(19) United States
(12) Patent Application Publication
(10) Pub. No.: US 2006/0000094 A1
(43) Pub. Date: Jan. 5, 2006

(54) Forged aluminum vehicle wheel and associated method of manufacture and alloy

(76) Inventors: Carl E. Garesché, Streetsboro, OH (US); Dhruba J. Chakrabarti, Export, PA (US); Gregory Nowoslawski, Parma, OH (US); Robert M. Fecke, Westlake, OH (US); Matthew Charles Brest, Hudson, OH (US)

Correspondence Address: ECKERT SEAMANS CHERIN & MELLOTT, 600 GRANT STREET, 44TH FLOOR, PITTSBURGH, PA, 15219, US

(21) Appl. No.: 11/138,589

(22) Filed: May 26, 2005

Related U.S. Application Data
(60) Provisional application No. 60/584,606, filed on Jul. 1, 2004.

(51) Int. Cl. B21K 1/38; B60B 21/00

(52) U.S. Cl. 29/894.353; 301/95.101; 29/894.35

(57) ABSTRACT

A method of making a forged aluminum vehicle wheel includes forging a low copper bearing 7000 series aluminum alloy into a wheel workpiece followed by initial cooling and machining and surface treatment. Aging which may be natural aging, artificial aging or both may be provided after cooling and before or after machining. Corresponding forged aluminum wheels are disclosed. The low copper bearing 7000 series forged aluminum wheel has superior fatigue properties. An alloy suitable for use in the method and wheel is disclosed.

### BACKGROUND OF THE INVENTION

1. Field of the Invention

The present invention relates to an improved forged aluminum vehicle wheel and a method of making such a wheel out of a low copper bearing 7000 series aluminum alloy.

2. Description of the Prior Art

It has been known to employ aluminum alloys in the manufacture of vehicle wheels. U.S. Pat. No. 6,315,367 discloses a cast aluminum truck wheel which was said to eliminate the welding of a separately manufactured wheel disc and wheel rim.

It has long been known to employ aluminum alloy 6061 in the commercial manufacture of truck wheels. It has been known to create forged aluminum alloy wheels made from alloy 6061 by subjecting the forging to solution heat treatment followed by a water quench and artificial aging. It has also been known to suggest the use of casting alloy 356 in making wheels. See generally U.S. Pat. No. 4,316,637.

U.S. Pat. No. 4,345,360 discloses an extrudable aluminum alloy which is extruded, cut, deformed to the desired shape and welded such as by cold pressure welding.

The use of aluminum wheels on commercial vehicles was suggested in U.S. Pat. No. 5,026,122. See also the two-piece wheel disclosure of U.S. Pat. No. 5,740,609.

The use of aluminum alloy 6061 as well as 5454 and A356 was disclosed in U.S. Pat. No. 5,441,334. See also U.S. Pat. No. 5,210,948 which disclosed an aluminum alloy 6013 wheel for a track-laying vehicle (e.g., tank).

The use of copper bearing aluminum alloy 7075 has been disclosed for use in the generally C-shaped tread member on a non-pneumatic tire wheel combination. See U.S. Pat. No. 4,558,727.

Published U.S. patent application 2002/0003373 discloses the use of copper bearing aluminum alloys 7050 and 7075 in creating cold forged wheels and spun light alloy rims. The rim is said to be made of a 5000 series aluminum alloy which is said to have strength and light weight similar to a cold forged alloy rim.

U.S. Pat. No. 4,490,189 discloses stamping or forging of 2000, 6000 or 7000 series aluminum alloys, but does not relate to the vehicle wheels and focuses on certain sequences of thermal treatments.

In spite of the aforegoing disclosures, there remains a very real and substantial need for wheels having improved properties.

### SUMMARY OF THE INVENTION

The present invention has met the hereinbefore described needs.

One embodiment of the method of making a forged aluminum vehicle wheel includes forging a low copper 7000 series aluminum alloy ingot into a wheel workpiece, initially cooling the forged wheel workpiece, machining the workpiece and surface-treating the workpiece.

The forged aluminum vehicle wheel made with a low copper bearing 7000 series alloy is characterized by improved fatigue properties as compared with 6061 wheels.

The invention includes a unique alloy suitable for use in the wheel.

It is an object of the present invention to provide a method of making a forged aluminum wheel and the resultant wheel which will have desired strength and decreased weight with similar fatigue life.

It is another object of the present invention to provide a method of making a forged aluminum vehicle wheel and the resultant wheel which exhibits improved fatigue properties.

It is a further object of the present invention to provide a method of making a forged aluminum vehicle heel which minimizes the post-forging distortion due to residual stresses established through prior art post-forming water quenching.

It is a further object of the present invention to provide modified thermal treatments which facilitate reduction in undesired distortion of the wheel.

It is another object of the invention to provide a method of making a forged low copper bearing 7000 series aluminum wheel which requires less post forming machining.

It is a further object of the invention to provide an alloy which may be employed in the method and wheel.

It is a further object of the present invention to provide such a method and associated forged aluminum wheel which will have increased strength.

These and other objects of the invention will be more fully understood from the following detailed description of the invention on reference to the illustrations appended hereto.

### BRIEF DESCRIPTION OF THE DRAWINGS

FIG. 1 is a flow diagram showing a first embodiment of the method of the present invention.

FIG. 2 is a flow diagram of another embodiment of the methods of the present invention.

FIG. 3 is a flow diagram of another embodiment of the methods of the present invention.

FIG. 4 is a flow diagram of another embodiment of the methods of the present invention.

FIG. 5 is a flow diagram of another embodiment of the methods of the present invention.

FIG. 6 is a flow diagram of another embodiment of the methods of the present invention.

FIG. 7 is an illustration of a plot of load vs. cycles to fatigue crack initiation comparing aluminum forged one-piece wheels made of 6061 alloy with aluminum forged one-piece wheels made of low copper bearing 7000 series aluminum alloy of the present invention.

### DESCRIPTION OF THE PREFERRED EMBODIMENTS

As employed herein, the term “vehicle” means a motorized wheeled vehicle having pneumatic tires and being structured to ride on and off roads and shall expressly include, but not be limited to, automobiles, Class 1-8 trucks, sport utility vehicles, vans, pick-up trucks, buses, recreational vehicles, motorcycles, construction vehicles, trailers structured to be pulled by a motorized tractor, boat trailers and campers.

As employed herein, the term “wheel workpiece” means a workpiece which alone or when joined to one or more components will become a vehicle wheel.

As employed herein, the tern “low copper” means either (1) no copper or (2) copper being present in an amount under the recited ceiling.

All references to percentages herein unless expressly indicated to the contrary shall refer to weight percent.

The present invention is a forged aluminum vehicle wheel made from a low copper bearing 7000 series aluminum alloy and the method of making the same.

The method of the present invention involves making a forged aluminum vehicle wheel from a low copper bearing 7000 series aluminum alloy ingot into a wheel workpiece. Forging is followed by initial cooling at the rate of less than 30° F./sec and preferably less than 15° F./sec and most preferably about 0.1° F./sec to 4° F./sec followed by machining the wheel workpiece and surface treatment.

A preferred low copper bearing 7000 series aluminum alloy has a composition on a weight basis of about 3 to 7% zinc, about 0.5 to 2% magnesium, less than 1% manganese, less than 0.3% chromium, about 0.05 to 0.3% zirconium, less than 0.2% titanium, less than 0.2% copper and as impurities up to 0.4% iron and up to 0.35% silicon with the balance being aluminum.

Another preferred low copper bearing 7000 series aluminum alloy has a composition on a weight basis of about 3.6 to 4.6% zinc, about 0.7 to 1.5% magnesium, less than 0.7% manganese; less than 0.2% chromium, about 0.05 to 0.18% zirconium, less than 0.1% titanium, less than 0.1% copper and as impurities a total of iron and silicon up to about 0.5% with the balance being aluminum.

The most preferred low copper bearing 7000 series aluminum alloy will have the following composition on a weight basis: about 3.6 to 4.6% zinc; about 0.7 to 1.5% magnesium; about 0.1 to 0.5% manganese; about 0.06 to 0.2% chromium; about 0.05 to 0.18% zirconium; about 0.02 to 0.06% titanium; less than 0.1% copper, and as impurities a total of iron and silicon up to about 0.5% with the balance being aluminum. Copper may be present in about 0.02 to 0.1 weight percent.

One of the advantages of the present invention is that it does not require the traditional solution heat treatment followed by water quenching which tended to build up internal stresses in the wheel thereby contributing to distortion, the use of more material and the requirement of additional machining.

In the present invention, the initial post-forming cooling may be in the form of an air quench and may be through still or forced (e.g., fan or compressed) air. This initial cooling preferably cools the wheel workpiece to at least 400° F. and may cool it to ambient temperature. Natural aging may be effected for several days and preferable about one hour to seven days followed by artificial aging. The artificial aging may be effected over a period of about one to eight hours at a first temperature of about 200 to 250° F. and subsequently at about 290 to 360° F. for about two to sixteen hours.

Among the preferred alloys for use in the present invention are 7004, 7005, 7108, 7003, 7008, 7108A, 7018, 7019, 7019A, 7020 and 7021 aluminum alloys.

The low copper bearing 7000 series aluminum alloy temper employed in making the wrought wheel of the present invention preferably is T5 temper. If desired, other tempers such as T1, T6 and T7 may be used.

It will be appreciated that as well known to those skilled in the art, the wheel workpiece can be so structured as to become a one-piece wheel having an integrally formed wheel disc and surrounding rim. It can also be a separate disc and surrounding rim which will be joined to as by at least one securement selected from the group consisting of welding and mechanical fasteners to create a wheel structure. The low copper bearing 7000 series aluminum alloy of the present invention is readily weldable for this purpose.

After completion of artificial aging which effects the desired strengthening of the wheel or wheel workpiece, the wheel workpiece is machined, may be surface pre-stressed to impart a compressive residual stress state to enhance fatigue performance and consistency, is surface-finished and typically provided with a protective coating.

The protective coating may be a curable coating which may be cured at an elevated temperature which also may be a step of the artificial aging. Curing may, for example, be effected at about 300° F. to 380° F. for about ten to eighty minutes. The protective coating provides corrosion resistance.

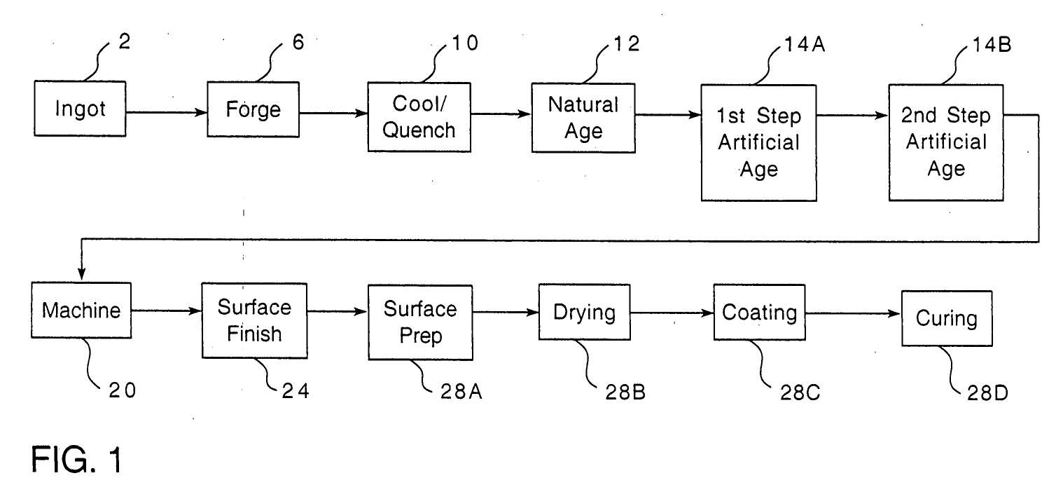

Referring to FIG. 1, a first embodiment of the method of the present invention will be considered. An aluminum ingot 2 in the low copper bearing 7000 series aluminum alloy is subjected to forging 6 at about 200 to 1000° F., for example, to produce a wheel workpiece which is subsequently cooled by a forced air quench 10 which preferably reduces the temperature to about 100 to 400° F. after which the aluminum wheel workpiece is subjected to natural aging 12 which in the example illustrated may be for about one hour to seven days. Subsequently, the workpiece is subjected to artificial aging 14 which in the preferred approach is a two-step process with the first step 14A being at about 200 to 250° F. for about one to eight hours and followed by a second step 14B at about 290 to 360° F. for about two to sixteen hours with the total time of both artificial aging steps being about three to twenty-four hours. The wheel workpiece is then machined 20 to achieve the desired shape and is surface-finished 24 to achieve the desired appearance, for example, polished, textured or satin-finished. The wheel workpiece is then given a protective coating which, for example, may include surface preparation 28A, cleaning and/or etching and/or anodizing, drying 28B at about room temperature to 250° F., polymeric coating 28C, for example, with an acrylic coating and curing the coating 28D at about 300 to 380° F. for about ten to eighty minutes.

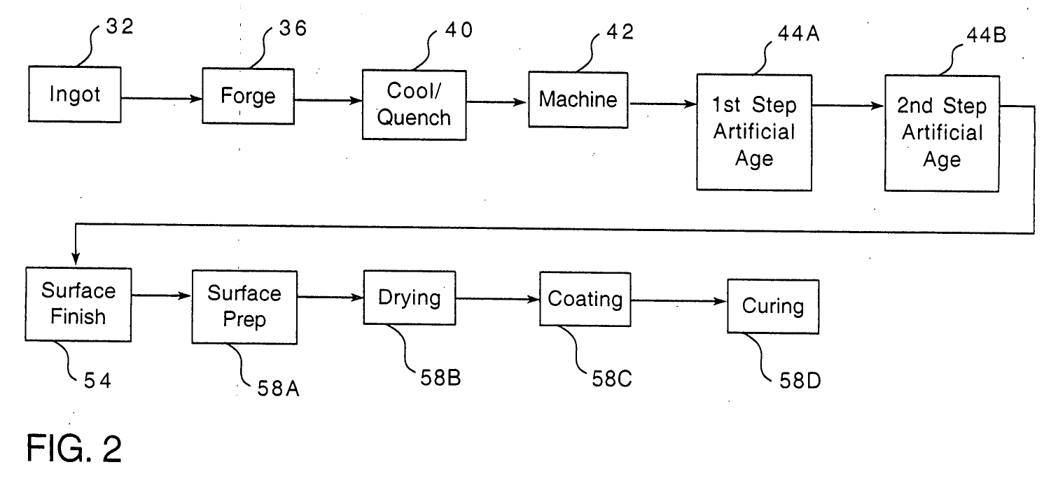

Turning now to another embodiment of the method of the present invention and referring to FIG. 2, there is shown an aluminum ingot 32 in the low copper bearing 7000 series aluminum alloy that is subjected to forging 36 at about 200 to 1000° F. to produce a wheel workpiece which is subsequently cooled by a forced air quench 40 which preferably reduces the temperature to about 100 to 400° F. after which the aluminum wheel workpiece is subjected to machining 42 to achieve the desired shape. Subsequently, the workpiece is subjected to artificial aging 44 which in the preferred approach is a tvo-step process with the first step 44A being at about 200 to 250° F. for about one to eight hours and followed by a second step 44B at about 290 to 360° F. for about two to sixteen hours with the total time of both artificial aging steps being about three to twenty-four hours. The wheel workpiece is then surface-finished 54 to achieve the desired appearance, for example, polished, textured or satin-finished. The wheel workpiece is then given a protective coating, within process steps including, for example, surface preparation 58A, cleaning and/or etching and/or anodizing, drying 58B at about room temperature to 250° F., polymeric coating 58C, for example, with acrylic coating and curing the coating 58D at about 300 to 380° F. for about ten to eighty minutes.

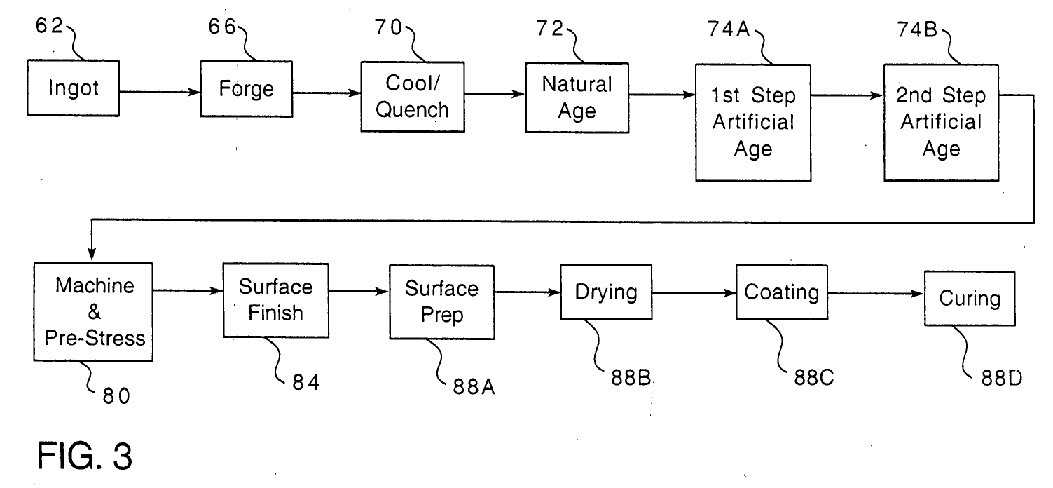

Turning now to another embodiment of the method of the present invention and referring to FIG. 3, there is shown an aluminum ingot 62 in the low copper bearing 7000 series aluminum alloy that is subjected to forging 66 at about 200 to 1000° F. to produce a wheel workpiece which is subsequently cooled by a forced air quench 70 which preferably reduces the temperature to about 100 to 400° F. after which the aluminum wheel workpiece is subjected to natural aging 72 which in the example illustrated may be for about one hour to seven days. Subsequently, the workpiece is subjected to artificial aging 74 which in the preferred approach is a two-step process with the first step 74A being at about 200 to 250° F. for about one to eight hours and followed by a second step 74B at about 290 to 360° F. for about two to sixteen hours with the total time of both artificial aging steps being about three to twenty-four hours. The wheel workpiece is then machined and pre-stressed 80 to achieve the desired shape and compressive residual stress state in the surface, and then is surface-finished 84 to achieve the desired appearance, for example, polished, textured or satin-finished. The wheel workpiece is then give a protective coating, with process steps comprising: surface preparation 88A, for example, cleaning and/or etching and/or anodizing, drying 88B at about room temperature to 250° F., polymeric coating 88C. for example, with an acrylic coating and curing the coating 88D at about 300 to 380° F. for about ten to eight minutes.

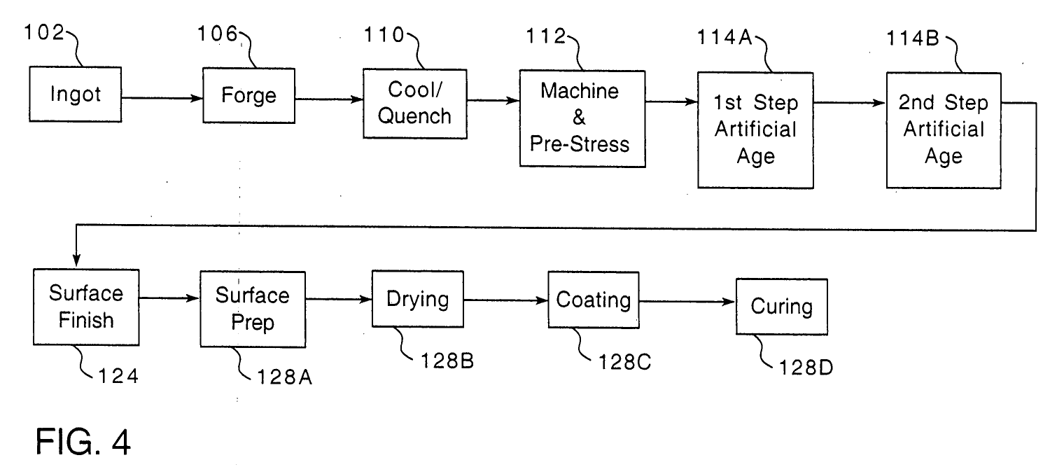

Turning now to another embodiment of the method of the present invention and referring to FIG. 4, there is shown an aluminum ingot 102 in the low copper bearing 7000 series aluminum alloy that is subjected to forging 106 at about 200 to 1000° F. to produce a wheel workpiece which is subsequently cooled by a forced air quench 110 which preferably reduces the temperature to about 100 to 400° F. after which the aluminum wheel workpiece is machined and pre-stressed 112 to achieve the desired shape and compressive residual stress state in the surface. Subsequently, the workpiece is subjected to artificial aging 114 which in the preferred approach is a two-step process with the first step 114A being at about 200 to 250° F. for about one to eight hours and followed by a second step 114B at about 290 to 360° F. for about two to sixteen hours with the total time of both artificial aging steps being about three to twenty-four hours. The wheel workpiece is then surface-finished 124 to achieve the desired appearance, for example, polished, textured or satin-finished. The wheel workpiece is then given a protective coating, with process steps comprising, for example, surface preparation 128A, cleaning and/or etching and/or anodizing, drying 128B at about room temperature to 250° F., polymeric coating 128C, for example, with an acrylic coating and curing the coating 128D at about 300 to 380° F. for about ten to eighty minutes.

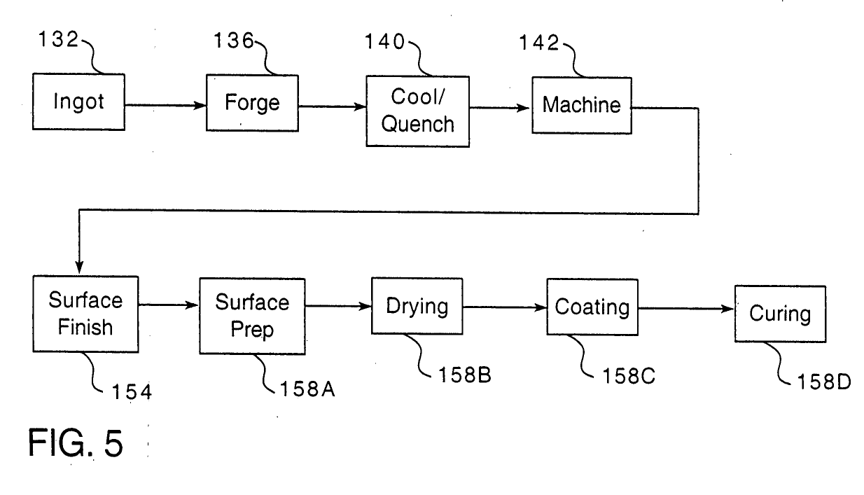

Turning now to another embodiment of the method of the present invention and referring to FIG. 5, there is shown an aluminum ingot 132 in the low copper bearing 7000 series aluminum alloy that is subjected to forging 136 at about 200 to 1000° F. to produce a wheel workpiece which is subsequently cooled by a forced air quench 140 which preferably reduces the temperature to about 100 to 400° F. after which the aluminum wheel workpiece is machined 142 to achieve the desired shape. The wheel workpiece is then surface-finished 154 to achieve the desired appearance, for example, polished, textured or satin-finished. The wheel workpiece is then given a protective coating, with process steps comprising, for example, surface preparation 158A, for example, cleaning and/or etching and/or anodizing, drying 158B at about room temperature to 250° F., polymeric coating 158C, for example, with an acrylic coating and curing the coating 158D at about 300 to 380° F. for about ten to eighty minutes. This embodiment of the method of the present invention illustrates forged aluminum wheel made with a low copper bearing 7000 series aluminum alloy in the T1 temper.

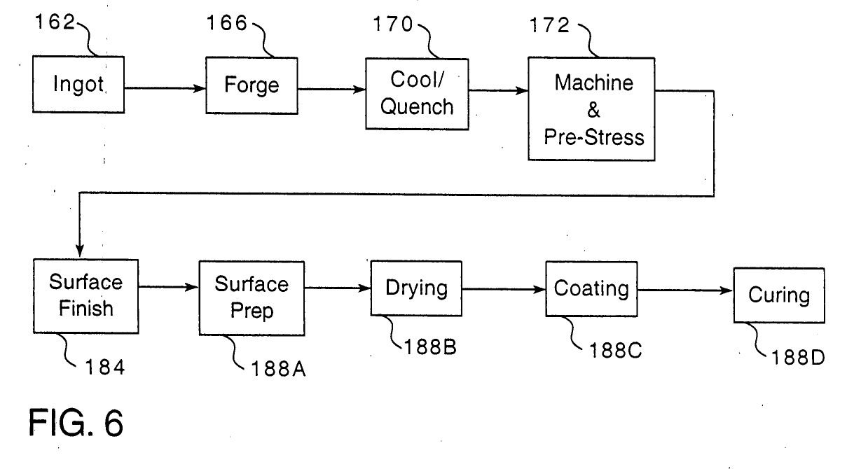

Turning now to another embodiment of the method of the present invention and referring to FIG. 6, there is shown an aluminum ingot 162 in the low copper bearing 7000 series aluminum alloy that is subjected to forging 166 at about 200 to 1000° F. to produce a wheel workpiece which is subsequently cooled by a forced air quench 170 which preferably reduces the temperature to about 100 to 400° F. after which the aluminum wheel workpiece is machined and pre-stressed 172 to achieve the desired shape and compressive residual stress state in the surface. The wheel workpiece is then surface-finished 184 to achieve the desired appearance, for example, polished, textured or satin-finished. The wheel workpiece is then given a protective coating, with process steps comprising, for example, surface preparation 188A, cleaning and/or etching and/or anodizing, drying 188B at about room temperature to 250° F., polymeric coating 188C, for example, with an acrylic coating and curing the coating 188D at about 300 to 380° F. for about ten to eighty minutes. This embodiment of the method of the present invention shows the forged and pre-stressed aluminum wheel made with a low copper bearing 7000 series aluminum alloy in the T1 temper.

It will be appreciated that as well known to those skilled in the art, the forged wheel workpiece may be one-piece forged or one-piece forged and spun, may be multiple-pieces welded and/or mechanically fastened, for example, with a stamped plate disc and rolled sheet rim, may be post-form quenched or cooled with still air, forced air, mist, spray or any other suitable means or media for achieving the cooling rate sought. It may be produced with or without a surface compressive residual stress state induced by pre-stressing. It may be produced with or without a surface finish. It may be produced with or without a protective coating, may have a polymeric protective coating such as, for example, an acrylic, polyester or other suitable material, a painted coating, a chrome plate coating or any other coating for the purpose of appearance and/or corrosion resistance. If desired, both a surface finish and a protective coating may be employed.

It will be appreciated that as well known to those skilled in the art, the wheel workpiece may be thermally treated to optimize combinations of natural and artificial aging in response to structure section thickness. One example of such optimization can include utilizing longer heat-up rates to the first step artificial aging temperature in lieu of natural aging time at ambient room temperature. It will also be appreciated that as well known to those skilled in the art, the artificial aging may be tailored somewhat to effect resultant material properties such as strength and corrosion resistance. Examples of such tailoring that are well known to those skilled in the art include coupling the degree to which equipment ramp-up temperatures (i.e., relatively slow heat-up rates) may be employed in conjunction with shorter hold times at temperature, and the preferred second step aging practice can be purposefully ramped up directly from the first step or there may be a purposeful and distinct time/temperature interruption between first and second steps. Another variation in artificial aging could reverse first and second steps. It is also generally known that ramping Lip to and/or down from a given or target treatment temperature, in itself, can produce aging effect which can, and often need to be, taken into account by integrating such ramping conditions and their aging effects into the total aging treatment. For instance, in a programmable air furnace, the temperature can be gradually progressively raised to temperature levels over a suitable length of time, even with no true hold time, to effect a suitable aging treatment, after which the metal can then be cooled to room temperature. This more continuous, aging regime with ramping and its corresponding integration of multiple temperature aging effects makes artificial aging possible in one continuous thermal treatment in a single, programmable furnace. For purposes of convenience and ease of understanding, however, preferred embodiments of this invention have been described in more detail as if each step was distinct from the other.

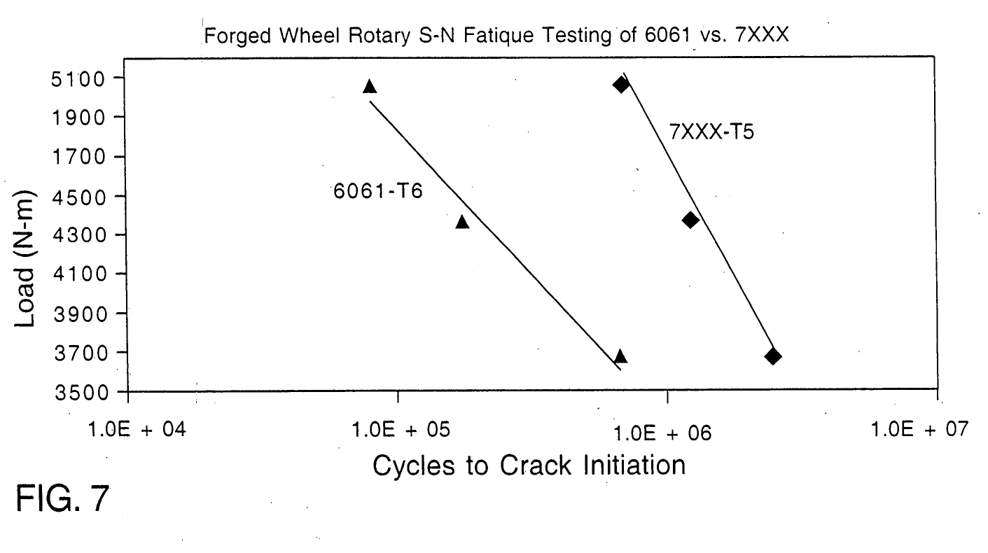

Referring now in greater detail to FIG. 7, there is shown the results of tests performed comparing the standard 6061 alloy with the low copper bearing 7000 series aluminum alloy as employed in making the forged aluminum vehicle wheels of the present invention. The test is a full wheel component rotary test with induced bending and is considered a meaningful test for this wheel design. FIG. 7 is a plot of load in Newton-meters (N-m) versus the logarithmic representation of cycles to fatigue crack initiation. In connection with the 6061 alloy, crack initiation for the 6061 at a load of approximately 5039 N-m occurred after an average of about 90,000 cycles as represented on the logarithmic scale, with subsequent crack initiations occurring at approximately 4344 N-m after an average of about 180,000 cycles and at approximately 3649 N-m after an average of about 670,000 cycles. In order to compare these fatigue test results with those of the present invention, it is seen that comparing plots of the low copper bearing 7000 series aluminum alloy fatigue testing within the 6061 tests, very substantial fatigue properties improvements were achieved by the present invention. In connection with the low copper bearing 7000 series aluminum alloy of the present invention, the crack initiation at a load of approximately 5039 N-m occurred after about 750,000 cycles as represented on the logarithmic scale, with subsequent crack initiations occurring at approximately 4344 N-m after an average of about 1,3000,000 cycles and at approximately 3649 N-m after about 2,500,000 cycles. Table I shows the test data.

TABLE I

| ALLOY | LOAD | CYCLES | CRACK INITIATION |
|---|---|---|---|
| 6061-T6 | 5039 | 100,000 | 90,000 |
| | 5039 | 90,000 | |
| | 5039 | 70,000 | |
| | 4344 | 200,000 | 180,000 |
| | 4344 | 200,000 | |
| | 4344 | 150,000 | |
| | 3649 | 823,000 | 670,000 |
| | 3649 | 646,359 | |
| | 3649 | 546,000 | |
| 7XXX-T5 | 5039 | 750,000 | 750,000 |
| | 4344 | 1,500,000 | 1,300,000 |
| | 4344 | 1,400,000 | |
| | 4344 | 1,050,000 | |
| | 3649 | 2,500,000 | 2,500,000 |

The presently preferred low copper bearing 7000 series aluminum alloys for use in present invention are 7004, 7005, 7108, 7003, 7008, 7108A, 7018, 7019, 7019A, 7020 and 7021 with T5, T1, T6 and T7 being the preferred tempers. When T6 or T7 is selected, it is preferred that air cooling be employed after solution heat treatment.

Another advantage of the present invention is the increased strength of the low copper bearing 7000 series aluminum alloy permits the wheel securing studs to be placed in greater tension. This increases the fatigue strength of the wheel. With existing generally employed studs and nuts, the present invention facilitates the use of nut torque of about 480 to 500 ft.-lb. and even higher torque with studs and nuts of greater strength.

While the wheels of the present invention may particularly advantageously be employed in Class 1 through 8 trucks as well as automobiles, advantageous use may be made in other vehicles as well.

Whereas particular embodiments of the invention have been described herein for purposes of illustration, it will be evident to those skilled in the art that numerous variations of the details may be made without departing from the invention as set forth in the appended claims.

1. A method of making a forged aluminum vehicle wheel comprising
forging a low copper bearing 7000 series aluminum alloy ingot into a wheel workpiece,
initially cooling said forged wheel workpiece,
aging said wheel workpiece, and
machining said wheel workpiece either before or after said aging.

2. The method of claim 1 including
selecting said aluminum alloy from the group consisting of 7004, 7005, 7008, 7003, 7108, 7108A, 7021, 7018, 7019, 7019A and 7020 aluminum alloys.

3. The method of claim 2 including
employing said aluminum alloy in a temper from the group consisting of T5, T1, T6 and T7.

4. The method of claim 1 including
said low copper bearing 7000 series aluminum alloy comprising on a weight basis:
about 3 to 7% zinc;
about 0.5 to 2% magnesium;
less than 1% manganese;
less than 0.3% chromium;
about 0.05 to 0.3% zirconium;
less than 0.2% titanium;
less than 0.2% copper
as impurities up to 0.4% iron, and
up to 0.35% silicon with the balance being aluminum.

5. The method of claim 4 including
effecting said initial cooling by an air quench.

6. The method of claim 5 including
effecting said initial cooling at a rate of less than about 30° F./sec.

7. The method of claim 6 including
effecting said initial cooling at a rate of about 0.1 to 4° F./sec.

8. The method of claim 4 including
after said initial cooling and before said machining, artificially aging said wheel workpiece.

9. The method of claim 8 including
effecting said artificial aging in two steps with the first step having a lower aging temperature than the second step.

10. The method of claim 9 including
effecting said first artificial aging at about 200 to 250° F. for about one to eight hours.

11. The method of claim 10 including
effecting said second artificial aging step at about 290 to 360° F. for about two to sixteen hours.

12. The method of claim 11 including
effecting said two stages of artificial aging for a total of about three to twenty-four hours.

13. The method of claim 9 including
after said initial cooling but prior to said artificial aging, naturally aging said workpiece for about one hour to seven days.

14. The method of claim 1 including
effecting surface treatment by establishing the desired surface appearance followed by applying a protective coating.

15. The method of claim 14 including
curing said protective coating.

16. The method of claim 1 including
after said initial cooling machining said wheel workpiece, and
after said machining artificially aging said machined wheel workpiece.

17. The method of claim 16 including
effecting said artificial aging in two steps with the first step being at a lower temperature than the second step.

18. The method of claim 17 including
effecting said first artificial aging step at about 200 to 250° F. for about one to eight hours, and
said second artificial aging step at about 290 to 360° F. for about two to sixteen hours.

19. The method of claim 18 including
after surface preparation drying said wheel workpiece.

20. The method of claim 19 including
after said drying applying a curable coating to said wheel workpiece.

21. The method of claim 20 including
curing said coating at about 300 to 380° F. for about ten to eighty minutes.

22. The method of claim 6 including
effecting said initial cooling to reduce said wheel workpiece temperature to about 100 to 400° F.

23. The method of claim 9 including
after said artificial aging pre-stressing said wheel workpiece.

24. The method of claim 9 including
after said initial cooling but prior to said artificial aging machining said wheel workpiece.

25. The method of claim 9 including
after said initial cooling but prior to said artificial aging pre-stressing said wheel workpiece.

26. The method of claim 1 including
after said initial cooling effecting said machining and surface finishing without artificial aging.

27. The method of claim 1 including
after said initial cooling effecting said machining followed by surface finishing and artificial aging.

28. The method of claim 1 including
employing said low copper bearing 7000 series alloy having a copper content of less than about 0.1%.

29. The method of claim 15 including
curing said coating at about 300 to 380° F. for about ten to eighty minutes.

30. The method of claim 16 including
said aging includes an integration of multiple temperature aging effects.

31. The method of claim 28 including
employing said low copper bearing 7000 series alloy having a copper content of about 0.02 to 0.1%.

32. The method of claim 1 including
employing as said low copper bearing aluminum alloy, an alloy having the composition: about 3.6 to 4.6% zinc; about 0.7 to 1.5% magnesium; about 0.1 to 0.5% manganese; about 0.06 to 0.2% chromium; about 0.05 to 0.18%.zirconium; about 0.02 to 0.06% titanium; less than 0.1% copper and as impurities a total of iron and silicon up to 0.5% with the balance being aluminum.

33. The method of claim 1 including
employing said method to create a one-piece vehicle wheel.

34. The method of claim 1 including
employing said method to create a multi-piece aluminum wheel, and
joining said workpieces by at least one securement selected from the group consisting of welding and mechanical fasteners.

35. The method of claim 2 including
employing 7005 as said aluminum alloy ingot.

36. The method of claim 35 including
creating said wheel in 7005-T5.

37. The method of claim 35 including
creating said wheel in 7005-T1.

38. The method of claim 35 including
creating said wheel in 7005-T6.

39. The method of claim 35 including
creating said wheel in 7005-T7.

40. The method of claim 2 including
employing 7004 as said aluminum alloy ingot.

41. The method of claim 40 including
creating said wheel in 7004-T5.

42. The method of claim 40 including
creating said wheel in 7004-T1.

43. The method of claim 40 including
creating said wheel in 7004-T6.

44. The method of claim 40 including
creating said wheel in 7004-T7.

45. The method of claim 2 including
employing 7108 as said aluminum alloy ingot.

46. The method of claim 45 including
creating said wheel in 7108-T5.

47. The method of claim 45 including
creating said wheel in 7108-T1.

48. The method of claim 45 including
creating said wheel in 7108-T6.

49. The method of claim 45 including
creating said wheel in 7108-T7.

50. The method of claim 1 including
employing said method to create a truck wheel.

51. The method of claim 1 including
employing said method to create an automobile wheel.

52. The method of claim 1 including
effecting said initial cooling with an air quench.

53. The method of claim 1 including
effecting said initial cooling with compressed air.

54. The method of claim 1 including
polishing said machined wheel workpiece.

55. The method of claim 54 including
subsequent to said polishing applying a protective coating to said wheel, and
curing said protective coating at an elevated temperature.

56. The method of claim 55 including
effecting said curing at about 300° F. to 380° F. for about ten to eighty minutes.

57. The method of claim 56 including
effecting artificial aging by said curing.

58. The method of claim 1 including
employing said alloy with a zirconium content on a weight percent basis of about 0.05-0.18%.

59. The method of claim 1 including
employing in said alloy about 3.6 to 4.6% zinc.

60. The method of claim 1 including
employing in said alloy about 0.7 to 1.5% magnesium.

61. The method of claim 59 including
employing in said alloy about 0.05 to 0.18% zirconium.

62. The method of claim 61 including
employing in said alloy about 0.02 to 0.06% titanium.

63. The method of claim 1 including
said low copper bearing 7000 series aluminum alloy comprising on a weight basis
of about 3.6 to 4.6% zinc, about 0.7 to 1.5% magnesium, less than 0.7% manganese; less than 0.2% chromium, about 0.05 to 0.18% zirconium, less than 0.1% titanium, less than 0.1% copper and as impurities a total of iron and silicon up to about 0.5% with the balance being aluminum.

64. The method of claim 63 including
creating said wheel in T5 temper.

65. The method of claim 63 including
creating said wheel in T1 temper.

66. The method of claim 63 including
creating said wheel in T6 temper.

67. The method of claim 63 including
creating said wheel in T7 temper.

68. The method of claim 32 including
creating said wheel in T5 temper.

69. The method of claim 32 including
creating said wheel in T1 temper.

70. The method of claim 32 including
creating said wheel in T6 temper.

71. The method of claim 32 including
creating said wheel in T7 temper.

72. A forged aluminum vehicle wheel comprising
said wheel composed of a low copper bearing 7000 series aluminum alloy.

73. The forged aluminum vehicle wheel of claim 72 including
said low copper bearing 7000 series alloy having a composition on a weight percent basis of about 3 to 7% zinc, about 0.5 to 2% magnesium, less than 1% manganese, less than 0.3% chromium, about 0.05 to 0.3% zirconium, less than 0.2% titanium, less than 0.2% copper and as impurities up to about 0.4% iron and LIP to ⁰.³⁵% silicon with the balance being aluminum.

74. The forged aluminum vehicle wheel of claim 72 including
said low copper bearing 7000 series aluminum alloy being in T5 temper.

75. The forged aluminum vehicle wheel of claim 72 including
said low copper bearing 7000 series aluminum alloy being in T1 temper.

76. The forged aluminum vehicle wheel of claim 72 including
said low copper bearing 7000 series aluminum alloy being in T6 temper.

77. The forged aluminum vehicle wheel of claim 72 including
said low copper bearing 7000 series aluminum alloy being in T7 temper.

78. The forged aluminum vehicle wheel of claim 73 including
said aluminum wheel being a one-piece forged aluminum wheel.

79. The forged aluminum vehicle wheel of claim 73 including
said aluminum wheel being a one-piece forged and spun aluminum wheel.

80. The forged aluminum vehicle wheel of claim 74 including
said aluminum wheel being a multi-piece aluminum wheel.

81. The forged aluminum vehicle wheel of claim 72 including
said 7000 series aluminum alloy having 0.02 to 0.1 weight percent copper.

82. The forged aluminum vehicle wheel of claim 80 including
said aluminum wheel being secured together by at least one securement selected from the group consisting of welding and mechanical fasteners.

83. The forged aluminum vehicle wheel of claim 73 including
limiting a combined total of iron and silicon of up to 0.50 weight percent.

84. The forged aluminum vehicle wheel of claim 73 including
said aluminum alloy having about 3.6 to 4.6 weight percent zinc.

85. The forged aluminum vehicle wheel of claim 73 including
said aluminum alloy having about 0.7 to 1.5 weight percent magnesium.

86. The forged aluminum vehicle wheel of claim 73 including
said aluminum alloy having less than 0.1 weight percent copper.

87. The forged aluminum vehicle wheel of claim 73 including
said aluminum alloy having about 0.02 to 0.1 weight percent copper.

88. The forged aluminum vehicle wheel of claim 73 including
said aluminum alloy having about 0.1 to 0.5 weight percent manganese.

89. The forged aluminum vehicle wheel of claim 73 including
said aluminum alloy having about 0.06 to 0.2 weight percent chromium.

90. The forged aluminum vehicle wheel of claim 73 including
said aluminum alloy having about 0.02 to 0.06 weight percent titanium.

91. The forged aluminum vehicle wheel of claim 73 including
said aluminum alloy having about 0.05 to 0.18 weight percent zirconium.

92. The forged aluminum vehicle wheel of claim 72 including
said wheel composed of 7005 aluminum alloy.

93. The forged aluminum wheel of claim 92 including
said 7005 aluminum alloy being 7005-T5.

94. The forged aluminum wheel of claim 92 including
said 7005 aluminum alloy being 7005-T1.

95. The forged aluminum wheel of claim 92 including
said 7005 aluminum alloy being 7005-T6.

96. The forged aluminum vehicle wheel of claim 92 including
said 7005 aluminum alloy being 7005-T7.

97. The forged aluminum vehicle wheel of claim 72 including
said wheel composed of 7004 aluminum alloy.

98. The forged aluminum vehicle wheel of claim 97 including
said 7004 aluminum alloy being 7004-T5.

99. The forged aluminum vehicle wheel of claim 97 including
said 7004 aluminum alloy being 7004-T1.

100. The forged aluminum vehicle wheel of claim 97 including
said 7004 aluminum alloy being 7004-T6.

101. The forged aluminum vehicle wheel of claim 97 including
said 7004 aluminum alloy being 7004-T7.

102. The forged aluminum vehicle wheel of claim 72 including
said wheel composed of 7108 aluminum alloy.

103. The forged aluminum vehicle wheel of claim 102 including
said 7108 aluminum alloy being 7108-T5.

104. The forged aluminum vehicle wheel of claim 102 including
said 7108 aluminum alloy being 7108-T1.

105. The forged aluminum vehicle wheel of claim 102 including
said 7108 aluminum alloy being 7108-T6.

106. The forged aluminum vehicle wheel of claim 102 including
said 7108 aluminum alloy being 7108-T7.

107. The forged aluminum wheel of claim 72 including
said aluminum wheel being a one-piece aluminum wheel.

108. The forged aluminum wheel of claim 72 including
said aluminum wheel being a two-piece aluminum wheel.

109. The forged aluminum wheel of claim 108 including
said two piece aluminum wheel forged aluminum vehicle wheel having a disk and rim secured together by at least one securement selected from the group consisting of welding and mechanical fasteners.

110. The forged aluminum wheel of claim 93 including
said aluminum alloy having about 0.02 to 0.1 weight percent copper.

111. The forged aluminum vehicle wheel of claim 72 including
said low copper bearing 7000 series aluminum alloy comprising on a weight basis
of about 3.6 to 4.6% zinc, about 0.7 to 1.5% magnesium, less than 0.7% manganese; less than 0.2% chromium, about 0.05 to 0.18% zirconium, less than 0.1% titanium, less than 0.1% copper and as impurities a total of iron and silicon up to about 0.5% with the balance being aluminum.

112. The forged aluminum vehicle wheel of claim 111 including
creating said wheel in T5 temper.

113. The forged aluminum vehicle wheel of claim 111 including
creating said wheel in T1 temper.

114. The forged aluminum vehicle wheel of claim 111 including
creating said wheel in T6 temper.

115. The forged aluminum vehicle wheel of claim 111 including
creating said wheel in T7 temper.

116. The forged aluminum vehicle wheel of claim 73 including
creating said wheel in T5 temper.

117. The forged aluminum vehicle wheel of claim 73 including
creating said wheel in T1 temper.

118. The forged aluminum vehicle wheel of claim 73 including
creating said wheel in T6 temper.

119. The forged aluminum vehicle wheel of claim 73 including
creating said wheel in T7 temper.

120. The forged aluminum vehicle wheel of claim 72 including
said aluminum alloy selected from the group consisting of 7004, 7005, 7008, 7003, 7108, 7108A, 7021, 7018, 7019, 7019A and 7020 aluminum alloys.

121. The forged aluminum vehicle wheel of claim 73 which has been artificially aged by a method comprising
a first artificial aging step at about 200 to 250° F., and
a second artificial aging step of about 290 to 360° F.

122. The forged aluminum vehicle wheel of claim 121 wherein said first artificial aging step has a duration of about one to eight hours, and
said second artificial aging step has a duration of about tvo to sixteen hours.

123. The forged aluminum vehicle wheel of claim 73 wherein said wheel has been artificially aged and said aging includes an integration of multiple temperature aging effects.

124. An aluminum alloy comprising on a weight basis
about 3.6 to 4.6% zinc, about 0.7 to 1.5% magnesium, less than 0.7% manganese; less than 0.2% chromium, about 0.05 to 0.18% zirconium, less than 0.1% titanium, less than 0.1% copper and as impurities a total of iron and silicon up to about 0.5% with the balance being aluminum.

125. The aluminum alloy of claim 124 comprising
about 3.6 to 4.6% zinc; about 0.7 to 1.5% magnesium; about 0.1 to 0.5% manganese; about 0.06 to 0.2% chromium; about 0.05 to 0.18 zirconium; about 0.02 to 0.06% titanium; less than 0.1% copper, and as impurities a total of iron and silicon up to 0.5% with the balance being aluminum.

126. The aluminum alloy of claim 124 including
said copper being present in about 0.02 to 0.1 weight percent.

127. The method of claim 1 including
after said initial cooling artificially aging said wheel workpiece, and
after said artificial aging machining said wheel workpiece.

128. The method of claim 1 including
said forged aluminum vehicle wheel characterized by having improved fatigue properties as compared with forged aluminum vehicle wheels composed of 6061 aluminum alloy.

129. The forged aluminum vehicle wheel of claim 72 including
said forged aluminum vehicle wheel characterized by having improved fatigue properties as compared with forged aluminum vehicle wheels composed of 6061 aluminum alloy.
